(19) United States
(12) Patent Application Publication
(10) Pub. No.: US 2017/0219824 A1
(43) Pub. Date: Aug. 3, 2017

(54) MICRO-DISPLAY HAVING NON-PLANAR IMAGE SURFACE AND HEAD-MOUNTED DISPLAYS INCLUDING SAME

(71) Applicant: Google Inc., Mountain View, CA (US)

(72) Inventors: Bernard Kress, Redwood City, CA (US); Corey Tabaka, Los Gatos, CA (US)

(73) Assignee: Google Inc., Mountain View, CA (US)

(21) Appl. No.: 14/106,280

(22) Filed: Dec. 13, 2013

(51) Int. Cl. G02B 27/01

(52) U.S. Cl. CPC G02B 27/0172

(57) ABSTRACT

The disclosure describes an apparatus including a micro-display including an array of individual display pixels positioned along a substantially planar emission surface. An optical fixture is coupled to the substantially planar emission surface and optically coupled to the individual display pixels, wherein the optical fixture forms a virtual or real non-planar object surface of the micro-display.

### TECHNICAL FIELD

The present invention relates generally to micro-displays and in particular, but not exclusively, to micro-displays including non-planar image surfaces.

### BACKGROUND

In many off-axis Head-Mounted Display (HMD) or Heads-Up Display (HUD) architectures, the problem is that the micro-display is off the optical axis of the imaging optics (e.g., a collimation lens or combining lens) and must be oriented so that it is tilted or curved relative to the imaging optics. Because the micro-display is an object that is imaged in the far field by the imaging optics, this off-axis placement and angle of the micro-display relative to the imaging optics can cause the imaging optics to produce a virtual image, which is seen by a viewer, that is also tilted or curved.

One possible solution is to use non planar micro-displays, but this requires the custom development of special micro-displays that are not available today. Another solution is to produce an intermediate image that can be used as an effective micro-display surface, but this is very difficult with traditional lenses and impossible if the surface must have a specific orientation and shape (non-planar, tilted, etc.).

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A is a cross-sectional schematic view of an embodiment of an off-axis head-mounted display including a planar diffractive optical combiner.

FIGS. 1B-1C are, respectively, cross-sectional views of a micro-display with a substantially planar image surface and a non-planar image surface.

FIG. 2A is a plan view of an embodiment of a micro-display.

FIG. 2B is a cross-sectional view of the embodiment of a micro-display shown in FIG. 2A, taken substantially along section line B-B.

FIG. 2C is a cross-sectional view of another embodiment of the micro-display shown in FIG. 2B.

FIG. 3A is a plan view of another embodiment of a micro-display.

FIG. 3B is a cross-sectional view of the embodiment of a micro-display shown in FIG. 3A, taken substantially along section line B-B.

FIG. 3C is a cross-sectional view of another embodiment of the micro-display shown in FIG. 3B.

FIG. 4A is a plan view of another embodiment of a micro-display.

FIG. 4B is a cross-sectional view of the embodiment of a micro-display shown in FIG. 4A, taken substantially along section line B-B.

FIG. 5 is a top view of a binocular head mountable display using at least one micro-display.

### DETAILED DESCRIPTION OF THE ILLUSTRATED EMBODIMENTS

Embodiments are described of an apparatus, system and method for a micro-display using a non-planar image surface. Specific details are described to provide a thorough understanding of the embodiments, but one skilled in the relevant art will recognize that the invention can be practiced without one or more of the described details, or with other methods, components, materials, etc. In some instances, well-known structures, materials, or operations are not shown or described in detail but are nonetheless encompassed within the scope of the invention.

Reference throughout this specification to “one embodiment” or “an embodiment” means that the described feature, structure, or characteristic is included in at least one described embodiment. Thus, appearances of “in one embodiment” or “in an embodiment” do not necessarily all refer to the same embodiment. Furthermore, the particular features, structures, or characteristics can be combined in any suitable manner in one or more embodiments.

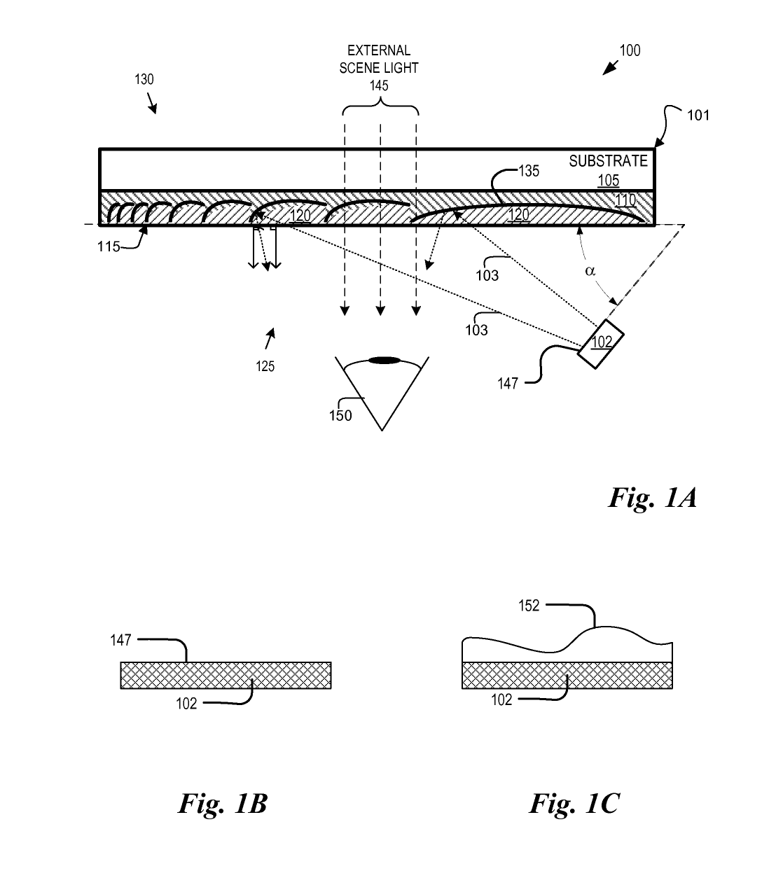

FIG. 1A illustrates an embodiment of a see-through heads-up or head-mounted display 100. Display 100 includes a sandwiched diffractive optical combiner 101 and a micro-display unit 102. Micro-display 102 is positioned off the optical axis of diffractive optical combiner 101 and has a substantially planar emission surface (the surface from which the individual display pixels in the micro-display emit light) that is positioned at an angle α relative to the plane of optical combiner 101.

Diffractive optical combiner 101 includes a substrate 105, a base sandwich layer 110, a reflective diffraction grating 115, a planarization sandwich layer 120, a back side 125, and a front side 110. Diffractive optical combiner 101 is referred to as a “sandwiched” optical combiner because it sandwiches reflective diffraction grating 115 between two material layers (i.e., base sandwich layer 110 and planarization sandwich layer 120) having substantially equal, if not identical, indices of refraction. By doing this, optical combiner 101 can simultaneously operate in both reflection and transmission modes with each mode having different characteristics. In reflection, micro-display unit 102 is positioned on the same side of optical combiner 101 as the user's eye 150 (i.e., back side 125) and emits display light 110 toward optical combiner 101. Optics 103 can be positioned in the optical path of display light 110 between display unit 102 and optical combiner 101 to apply compensation to display light 110 before the display light is incident upon optical combiner 101. Diffractive optical combiner 101 can be fabricated of a variety of clear optically transmissive materials, including plastic (e.g., acrylic, thermo-plastics, poly-methyl-methacrylate (PMMA), ZEONEX-E48R, glass, quartz, etc.).

Reflective diffraction grating 115 is formed of a two-dimensional (“2D”) array of three-dimensional (“3D”) diffraction element shapes formed into base sandwich layer 110 with partially reflective elements 135 coated onto the 3D diffraction element shapes and conforming thereto. The 3D diffraction element shapes can have parabolic cross-sectional shapes and rotationally symmetric (circular or spherical lens) or non-rotationally symmetric (aspheric lens) perimeter shapes, but other cross-sectional shapes and perimeter shapes (e.g., elliptical, etc.) can be used to create reflective diffraction grating 115.

Since reflective diffraction grating 115 is composed of partially reflective elements 135, a portion of display light 110 output from display unit 102 is reflected back towards user's eye 150. Similarly, in transmission the diffractive effects of reflective diffraction grating 115 can be annihilated by using the same or similar index of refraction material above and below partially reflective elements 135. Since partially reflective elements 135 are also partially transmissive and sandwiched in substantially uniform index material(s), the portion of external scene light 145 that passes through reflective diffraction grating 115 is not diffracted, but rather passes to eye 150 substantially without experiencing optical distortion or power.

Reflective diffraction grating 115 is formed by overlaying each 3D diffraction element shape with a partially reflective element 135. Partially reflective elements 135 each conformally coat a corresponding 3D diffraction element shape thereby creating a reflective structure that assumes the shape and orientation of the underlying 3D diffraction element shape. Partially reflective elements 135 can be made of a variety of different materials. In one embodiment, partially reflective elements 135 can be fabricated of a layer of conventional non-polarizing beam splitter material (e.g., thin silver layer, CrO2, etc.). The degree of reflectivity can be selected based upon the particular application (e.g., primarily indoor use, outdoor use, combination use, etc.). In one embodiment, partially reflective elements 135 comprise a 10% reflective 100 nm layer of CrO2. In another embodiment, partially reflective elements 135 are fabricated of a multi-layer dichroic thin film structure. Dichroic films can be created to have a selectable reflectivity at a selectable wavelength. In yet another embodiment, partially reflective elements 135 can be fabricated of polarizing beam splitter material that substantially reflects one linear polarization of incident light but substantially passes the orthogonal linear polarization.

By simultaneously operating diffractive optical combiner 101 in both reflective and transmissive modes, it can be used to overlay display light 110 onto external scene light 145 to provide a type of augmented reality to user's eye 150. In some embodiments, the shape, size, orientation, and placement of the individual 3D diffraction element shapes formed into base sandwich layer 110 can be designed to provide optical power for magnifying display light 110.

Micro-display 102 can be fabricated using a variety of compact image source technologies such as the various micro-displays used today in pico-projectors, liquid crystal on silicon (“LCOS”) displays, backlit liquid crystal displays, organic light emitting diode (“OLED”) displays, quantum dot array displays, light emitting diode (“LED”) arrays, or otherwise.

FIGS. 1B-1C illustrate embodiments of micro-displays with substantially planar and curved image surfaces. In FIG. 1B, micro-display 120 has a substantially planar emission surface 147—that is, the surface from which the display pixels in the micro-display emit their radiation. When this embodiment is used in an off-axis imaging system, substantially planar emission surface 147 would be the “object” surface imaged by an optical element coupled to the micro-display, such as a refractive, reflective, or diffractive lens. For example, if used in an HMD such as HMD 100, substantially planar emission surface 147 would be the object surface imaged by diffractive optical combiner 101. But a substantially planar emission surface like emission surface 147 is not necessarily the optimum image surface when display 102 is positioned off-axis at an angle α relative to an optical imaging element. The substantially planar emission surface 147 can create optical distortions in the final image seen by the user's eye 150. The nature and amount of optical distortion depends on various factors, for example angle ≢0 and the optical characteristics of the optical element with which micro-display 102 is paired.

FIG. 1C illustrates an embodiment of a micro-display 120 having an optical fixture that creates a non-planar real or virtual object surface 152 for the micro-display. In an off-axis optical system such as HMD 100, the optimal object surface might not be a planar emission surface, but rather a non-planar surface such as object surface 152. When this embodiment is used in an off-axis imaging system, non-planar object surface 152 would be the “object” surface imaged by an optical element coupled to the micro-display, such as a refractive, reflective, or diffractive lens. For example, if used in HMD 100, non-planar object surface 152 would be the object surface imaged by diffractive optical combiner 101. The illustrated embodiment shows a non-planar surface 152 with an arbitrary non-planar shape, but the actual shape of surface 152 needed to provide an improved optical image to user's eye 150 can depend on a variety of factors, such as angle α and the optical characteristics of the optical element with which the display is paired. Embodiments of micro-displays that include virtual or real non-planar object surfaces are further discussed below.

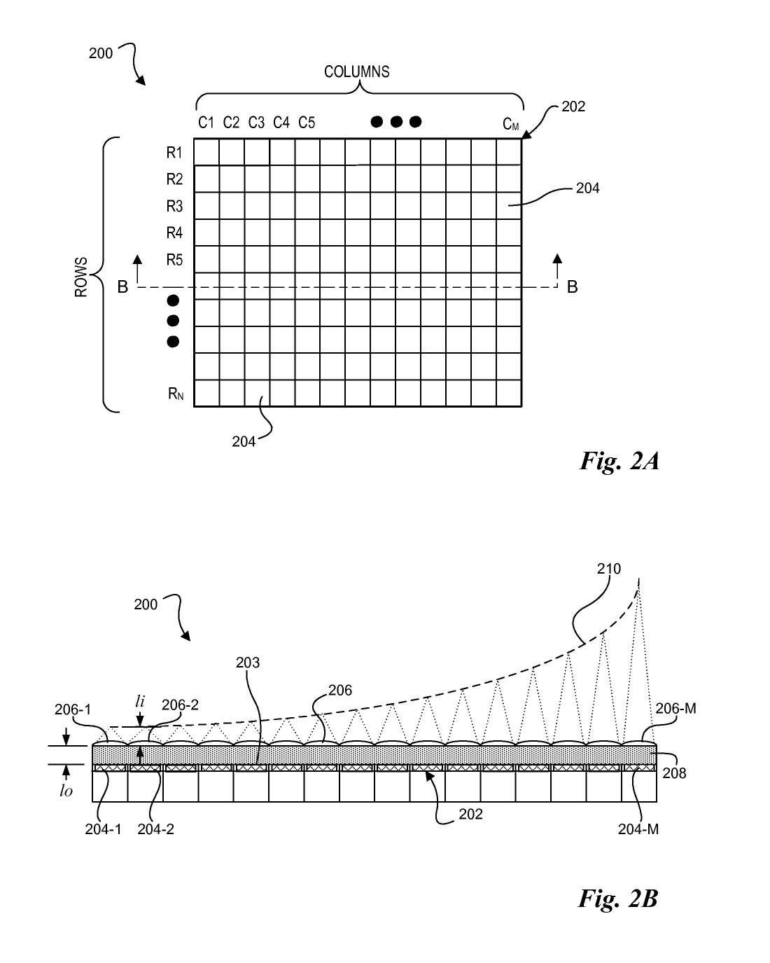

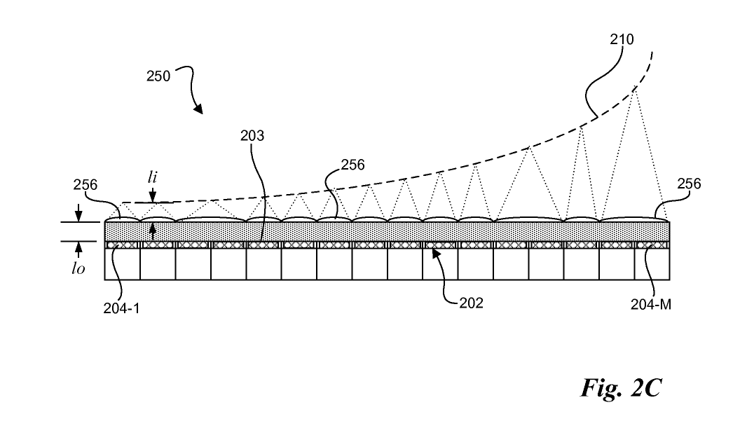

FIGS. 2A-2B illustrate an embodiment of a micro-display 200 including a virtual non-planar image surface. Micro-display 200 could be used in HMD 100 as a substitute for micro-display 120. FIG. 2A shows that micro-display 200 includes a pixel array 202 that in turn includes a plurality of individual display pixels 204. Individual display pixels 204 are positioned in the array in rows and columns, so that the array has M columns (C1-CM) and N rows (R1-RN). Although not illustrated in the drawing, micro-display 200 can also include electronic or other support elements for the display pixels, such as memory, controllers, light sources, and so on. Micro-display 200 can be made using a variety of compact image source technologies such as the various micro-displays used today in pico-projectors, liquid crystal on silicon (“LCOS”) displays, backlit liquid crystal displays, organic light emitting diode (“OLED”) displays, quantum dot array displays, light emitting diode (“LED”) arrays, or otherwise.

FIG. 2B illustrates a cross-section of micro-display 200 taken substantially along section line B-B in FIG. 2A. Micro-display 200 includes an array of individual microlenses 206 optically coupled to pixel array 202. In the illustrated embodiment, every display pixel 204 in the array is optically coupled to a corresponding microlens 206. For example, in the illustrated row display pixel 204-1 is optically coupled to microlens 206-1, display pixel 204-2 is optically coupled to microlens 206-2, and so on for the entire row and for every row in the array. As a result, in micro-display 200 there is a one-to-one correspondence between display pixels 204 and microlenses 206. But other micro-display embodiments need not have a one-to-one correspondence of display pixels to microlenses, nor does the pixel-to-microlens correspondence need to be uniform over the array (see, e.g., FIG. 2C).

In micro-display 200, the focal lengths of individual microlenses 206 are not uniform, meaning that different individual microlenses can have different focal lengths. The lens equation for each individual microlens 206 is:

$$\frac{1}{{l}_{o}} + \frac{1}{{l}_{i}} = \frac{1}{f} \qquad ( Eq . 1 )$$

where f is the focal length of the individual microlens, lo is the object distance, and li is the image distance. In the illustrated cross-section, microlenses 206 are formed on a separator layer 208 positioned on emission surface 203 (the surface from which the display pixels 204 in the micro-display emit their radiation). In one embodiment, separator layer 208 can be an optically transparent dielectric, but in other embodiments it can be of a different material. Separator layer 208 has substantially uniform thickness, meaning that all microlenses 206 are positioned at the same fixed object distance lo from emission surface 203. Each microlens 206 focuses the image of its corresponding display pixel 204 at the focal point of the microlens, at an image distance li from the lens plane. But, as can be seen from Eq. 1, because microlenses 206 can have different focal lengths f, the image distances li can be different for each microlens. This results in the focal point of each lens being in a different distances from emission surface 203.

With the focal points of the microlenses at different distances from emission surface 203, the locus of focal points of all microlenses 206 in the microlens array forms a virtual non-planar object surface 210. Virtual object surface 210 becomes the “object” seen by an optical element to which micro-display 200 is optically coupled. When imaged by an optical element such as a lens or diffractive optical element, micro-display 200 will be imaged as if virtual surface 210 were the physical surface of the object, instead of emission surface 203 as would be the case with a micro-display having a planar emission surface (see, e.g., FIG. 1B). The shape of virtual image surface 210 can be optimized, for example using optical design software, so that when used in a system such as HMD 100, the image of micro-display 200 projected into a user's eye 150 is optimized and of high quality.

FIG. 2C illustrates another embodiment of a micro-display 250. Micro-display 250 could be used in HMD 100 as a substitute for micro-display 120. Micro-display 250 is similar in most respects to micro-display 200: it includes a pixel array 202 with individual display pixels 204 arranged in an M×N grid of M columns and N rows. Micro-display 250 also includes an array of individual microlenses 256 that are optically coupled to individual display pixels 204.

The primary difference between micro-displays 200 and 250 is in the positioning of individual microlenses 256 relative to individual display pixels 204. In micro-display 200, there is a one-to-one correspondence of display pixels 204 to microlenses 206, meaning that each display pixel is coupled to a single corresponding microlens. But that need not be the case in every embodiment. As illustrated in micro-display 250, there can be a many-to-one correspondence between display pixels 204 and microlenses 256; in other words, there can be more than one display pixel optically coupled to each microlens 256. For example, in micro-display 250 some display pixels 204 have a 2:1 ratio with their corresponding microlens, meaning that two display pixels 204 share a single microlens 256, but in other embodiments the ratio of display pixels to microlenses can be set to any number. In some embodiments the correspondence of display pixels to microlenses can be the same over the entire pixel array 202, but in others the ratio of display pixels to microlenses need not be uniform over pixel array 202; in micro-display 250, for example, the ratio of display pixels to microlenses is one-to-one in some parts, many-to-one in others.

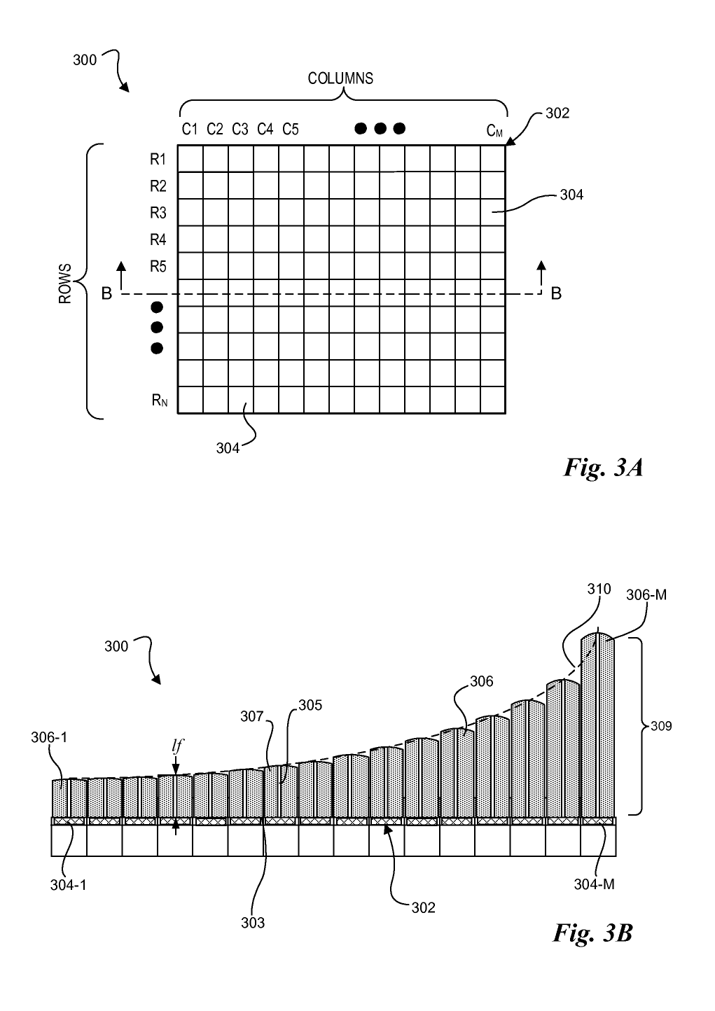

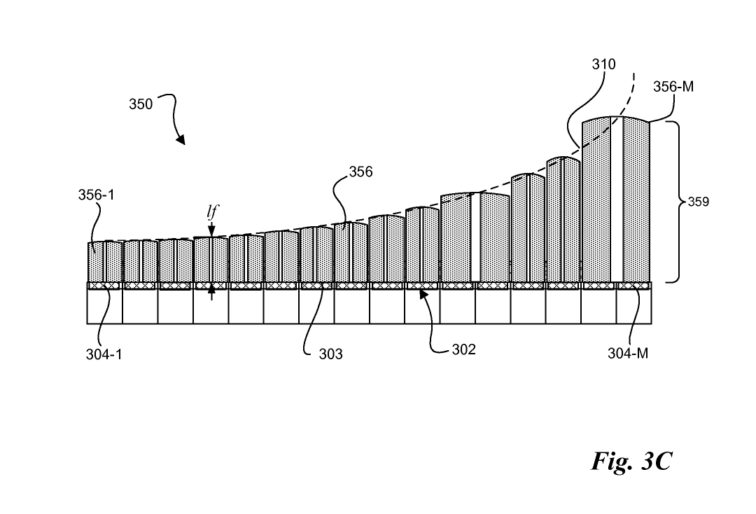

FIGS. 3A-3B illustrate an embodiment of a micro-display 300 with a real non-planar image surface. Micro-display 300 could be used in HMD 100 as a substitute for micro-display 120. FIG. 3A shows that micro-display 300 includes a pixel array 302 that in turn includes a plurality of individual display pixels 304. Individual display pixels 304 are positioned in the array in rows and columns, so that the array has M columns (C1-CM) and N rows (R1-RN). Although not illustrated in the drawing, micro-display 300 can also include electronic or other support elements for the display pixels, such as memory, controllers, light sources, and so on. Micro-display 300 can be fabricated using a variety of compact image source technologies such as the various micro-displays used today in pico-projectors, liquid crystal on silicon (“LCOS”) displays, backlit liquid crystal displays, organic light emitting diode (“OLED”) displays, quantum dot array displays, light emitting diode (“LED”) arrays, or otherwise.

FIG. 3B illustrates a cross-section of micro-display 300 taken substantially along section line B-B in FIG. 3A. Micro-display 300 includes a fiber bundle 309 optically coupled to emission surface 303. Fiber bundle 309 can be optically coupled to emission surface 303 using optical adhesives, for example. Fiber bundle 309 includes a plurality of individual optical fibers 306, each with a core 305 surrounded by cladding 307. In the illustrated embodiment, every individual display pixel 304 is optically coupled to a corresponding individual optical fiber 306. In the illustrated row, display pixel 304-1 is optically coupled to optical fiber 306-1, display pixel 304-2 is optically coupled to optical fiber 306-2, and so on for the entire row and for every row in the array. As a result, in micro-display 300 there is a one-to-one correspondence between individual display pixels 304 and individual optical fibers 306. But other micro-display embodiments need not have a one-to-one correspondence of display pixels to optical fibers, nor does the pixel-to-fiber correspondence need to be uniform over the array (see, e.g., FIG. 3C).

Each individual optical fiber 306 has a first end coupled to emission surface 303 and has a length if that can be different for each optical fiber. With length lf, each individual optical fiber has a second end that is at a distance if from emission surface 303. But because individual optical fibers in the fiber bundle can have different lengths lf, the locus of the fiber cores at the second end of each individual optical fiber 306 forms a non-planar surface 310 that becomes a real non-planar object surface of micro-display 300. With the ends of the individual optical fibers at different distances from emission surface 303, the locus of individual fiber ends 206 forms a real non-planar object surface 310. Real object surface 310 becomes the “object” seen by an optical element to which micro-display 300 is optically coupled. When imaged by an optical element such as a lens or diffractive optical element, micro-display 300 will be imaged as if surface 310 were the physical surface of the object, instead of emission surface 303 as to be the case with the display having a planar emission surface (see, e.g., FIG. 1B). The shape of virtual image surface 310 can be optimized, for example using optical design software, so that when micro-display 300 is substituted for micro-display 120 in an off-axis imaging system such as HMD 100, the image of micro-display 300 projected into a user's eye 150 is optimized and of high quality. The lengths of individual optical fibers 306, and hence the shape of non-planar object surface 310, can be adjusted, for example, by machining one end of fiber bundle 309 using CNC machining.

FIG. 3C illustrates another embodiment of a micro-display 350. Micro-display 350 could be used in HMD 100 as a substitute for micro-display 120. Micro-display 350 is similar in most respects to micro-display 300: it includes a pixel array 302 with individual display pixels 304 arranged in an M×N grid of M columns and N rows. Micro-display 350 also includes a fiber bundle 359 optically coupled to emission surface 303. Fiber bundle 359 includes a plurality of individual optical fibers 356 optically coupled to emission surface 303, each optically coupled to display pixels in pixel array 302.

The primary difference between micro-displays 350 and 300 is in the positioning of individual optical fibers 356 relative to individual display pixels 304. In micro-display 300, there is a one-to-one correspondence of display pixels 304 to optical fibers 306, meaning that each display pixel is optically coupled to a single corresponding optical fiber. But that need not be the case in every embodiment. As illustrated in micro-display 350, there can be a many-to-one correspondence between display pixels 304 and optical fibers 356; in other words, more than one display pixel can be optically coupled to each optical fiber 356. For example, in micro-display 350 some display pixels 304 have a 2:1 ratio with their corresponding optical fiber, meaning that two display pixels 204 share a single optical fiber 306, but in other embodiments the ratio of display pixels to optical fibers can be set differently. In some embodiments the correspondence of display pixels to optical fibers can be the same over the entire pixel array 302, but in others the ratio of display pixels to optical fibers need not be uniform over pixel array 302; in micro-display 350, for example, the ratio of display pixels to optical fibers is one-to-one in some parts, many-to-one in others.

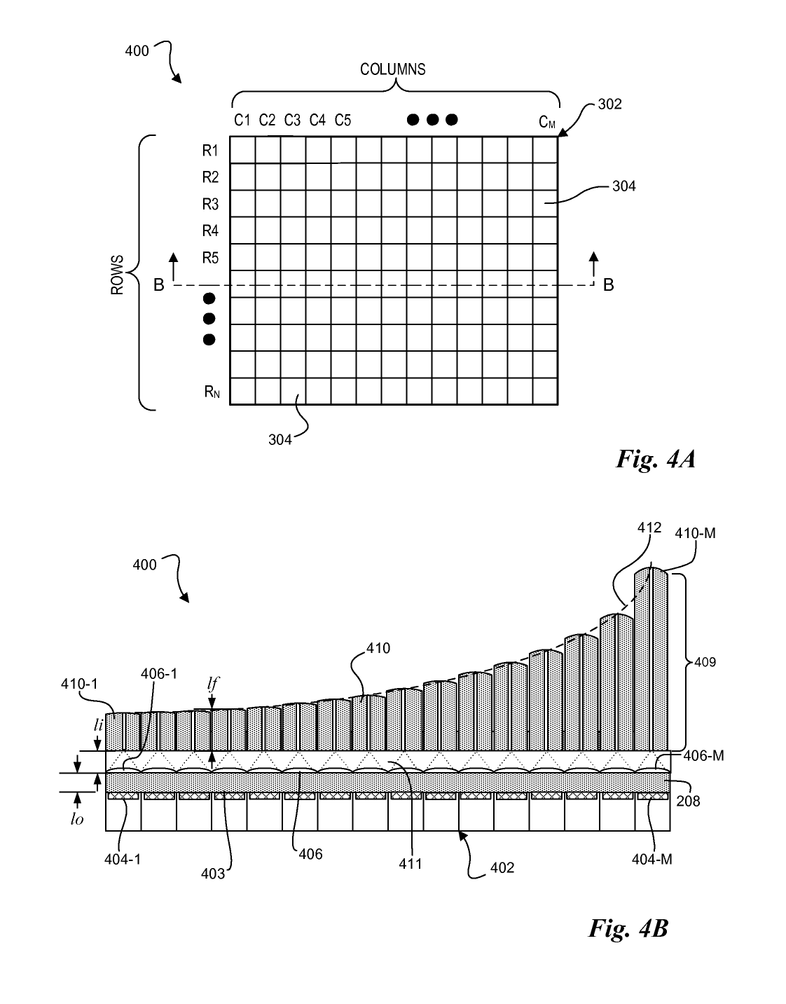

FIGS. 4A-4B illustrate another embodiment of a micro-display 400 that combines features from micro-displays 200 and 300. Micro-display 400 could be used in HMD 100 as a substitute for micro-display 120. FIG. 4A shows that micro-display 400 includes a pixel array 402 that in turn includes a plurality of individual display pixels 404. Individual display pixels 404 are positioned in the array in rows and columns, so that the array has M columns (C1-CM) and N rows (R1-RN). Although not illustrated in the drawing, micro-display 400 can also include electronic or other support elements for the display pixels, such as memory, controllers, light sources, and so on. Micro-display 400 can be fabricated using a variety of compact image source technologies such as the various micro-displays used today in pico-projectors, liquid crystal on silicon (“LCOS”) displays, backlit liquid crystal displays, organic light emitting diode (“OLED”) displays, quantum dot array displays, light emitting diode (“LED”) arrays, or otherwise.

FIG. 4B illustrates a cross-section of micro-display 400 taken substantially along section line B-B in FIG. 4A. An array of individual microlenses 406 is optically coupled to pixel array 402, and a fiber bundle 409 including a plurality of optical individual optical fibers 410 is coupled to the microlens array.

In the illustrated embodiment, every display pixel 404 in the array is optically coupled to a corresponding microlens 406, so that micro-display 400 has a one-to-one correspondence between display pixels 404 and microlenses 406. Microlenses 206 are formed on a separator layer 208 positioned on emission surface 203. In one embodiment, separation layer 408 can be an optically transparent dielectric, but in other embodiments it can be of a different material. Separator layer 408 has substantially uniform thickness, meaning that all microlenses 406 are positioned at the same fixed object distance lo from emission surface 403. Each microlens 406 focuses the image of its corresponding display pixel 404 at the focal point of the microlens, at an image distance li from the lens plane, according to Eq. 1. In this embodiment, microlenses 406 have the same focal lengths f so that the image distance li is the same for each microlens, meaning that the locus of focal points is substantially a plane.

Fiber bundle 409 is optically coupled to a substantially planar spacing layer 411 positioned above microlens array 402, for example using optical adhesives. The thickness of spacing layer 411 can be adjusted so that each individual optical fiber 410 is optically coupled to an individual microlens, with the core of each individual optical fiber positioned at the focal point of each individual microlens so that each microlens focuses light from its corresponding display pixel into the corresponding fiber core. Second spacing layer 411 can be used to position the fiber ends at the focal points of the microlenses.

Each individual optical fiber 410 has a first end coupled to spacing layer 411 and has a length if that can be different for each optical fiber. With length lf, each individual optical fiber has a second end that is at a distance if from spacing layer 411. But because individual optical fibers in the fiber bundle can have different lengths lf, the locus of the fiber cores at the second end of each individual optical fiber 410 forms a real non-planar surface 412 that becomes a real object surface of micro-display 400. Real object surface 412 becomes the “object” seen by an optical element to which micro-display 400 is optically coupled. When imaged by an optical element such as a lens or diffractive optical element, micro-display 400 will be imaged as if surface 412 were the physical surface of the object, instead of emission surface 403 as to be the case with the display having a planar emission surface (see, e.g., FIGS. 1A-1B). The shape of image surface 412 can be optimized, for example using optical design software, so that when micro-display 400 is substituted for micro-display 120 in an off-axis imaging system such as HMD 100, the image of micro-display 400 projected into a user's eye 150 is optimized and of high quality. The lengths of individual optical fibers 410, and hence the shape of non-planar object surface 412, can be adjusted, for example, by machining one end of fiber bundle 409 using CNC machining.

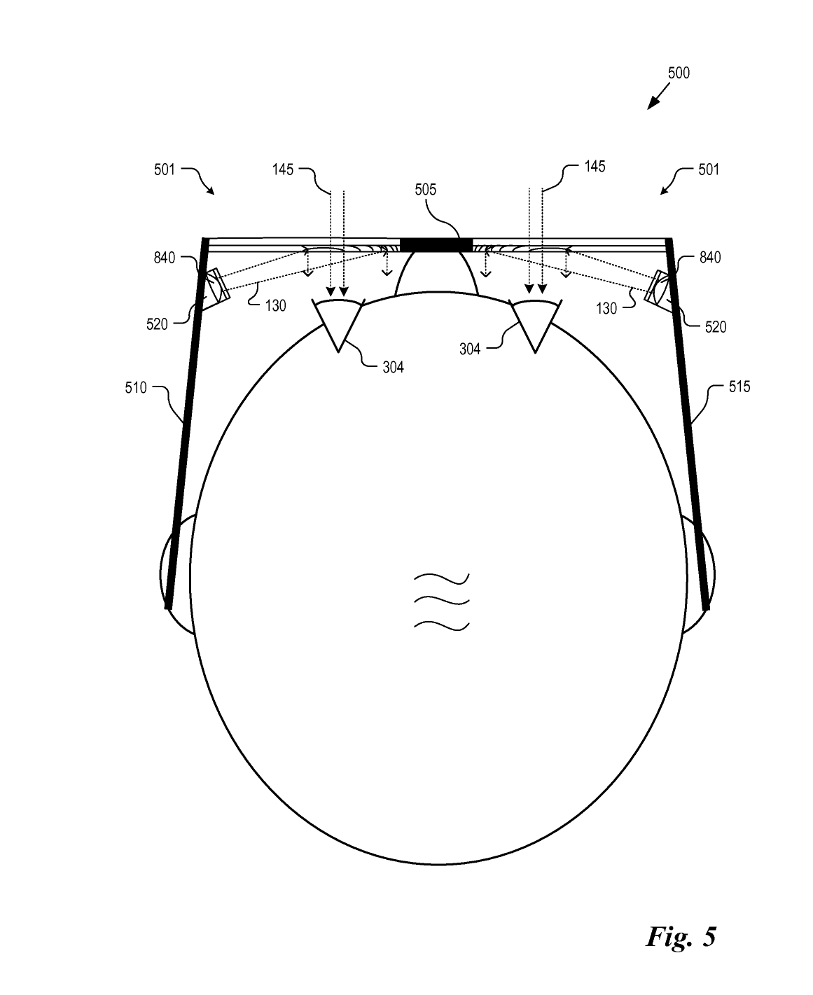

FIG. 5 is a top view of a binocular head-mounted display (HMD) 500 using a pair of see-through displays 501. Each see-through display 501 can be implemented with embodiments of micro-displays 200, 250, 300, 350 and/or 400. See-through displays 501 are mounted to a frame assembly, which includes a nose bridge 505, left ear arm 510, and right ear arm 515. Although FIG. 7 illustrates a binocular embodiment, HMD 500 can also be implemented as a monocular HMD.

See-through displays 501 are secured into an eyeglass arrangement that can be worn on the head of a user. The left and right ear arms 510 and 515 rest over the user's ears while nose assembly 505 rests over the user's nose. The frame assembly is shaped and sized to position each diffractive optical combiner in front of a corresponding eye 304 of the user. Of course, other frame assemblies having other shapes can be used (e.g., a visor with ear arms and a nose bridge support, a single contiguous headset member, a headband, goggles type eyewear, etc.).

The illustrated embodiment of HMD 500 is capable of displaying an augmented reality to the user. Each see-through display 501 permits the user to see a real world image via external scene light 145. Left and right (in a binocular embodiment) display light 130 can be generated by display units 520 mounted to left and right ear arms 510. One or both of display units 520 can be implemented using any of micro-displays 200, 250, 300, 350 and/or 400. Display light 130 can be pre-compensated by optics coupled to the display units to correct for optical aberrations introduced by the diffractive optical combiner upon reflection into eyes 304. Display light 130 is seen by the user as a virtual image superimposed over external scene light 145 as an augmented reality. In some embodiments, external scene light 145 can be partially blocked or selectively blocked to provide sun shading characteristics and increase the contrast of display light 130.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1-20. (canceled)

21. An apparatus comprising:
a micro-display including an array of individual display pixels positioned along a substantially planar emission surface; and
a microlens array comprising a plurality of individual microlenses physically coupled to the planar emission surface, wherein each individual microlens is optically coupled to one or more individual display pixels and wherein each individual microlens focuses an image of the one or more individual display pixels to which it is optically coupled at a focal point;
wherein every individual microlens in the microlens array is positioned at substantially the same object distance from the one or more display pixels to which it is optically coupled, and wherein the focal lengths of the plurality of individual microlenses are not uniform over the microlens array, so that the plurality of focal points of the microlens array are at different image distances from the emission surface, and so that a locus of the plurality of focal points forms a non-planar virtual object surface.

22. The apparatus of claim 21, further comprising an optically transparent dielectric separation layer between the planar emission surface and the microlens array.

23. The apparatus of claim 21 wherein there is a one-to-one correspondence between the individual display pixels and the individual microlenses.

24. The apparatus of claim 21 wherein there is a many-to-one correspondence between the individual display pixels and the individual microlenses.

25. A system comprising:
a micro-display unit comprising:
a micro-display including an array of individual display pixels positioned along a substantially planar emission surface, and
a microlens array comprising a plurality of individual microlenses physically coupled to the planar emission surface, wherein each individual microlens is optically coupled to one or more individual display pixels and wherein each individual microlens focuses an image of the one or more individual display pixels to which it is optically coupled at a focal point,
wherein every individual microlens in the microlens array is positioned at substantially the same object distance from the one or more display pixels to which it is optically coupled, and wherein the focal lengths of the plurality of individual microlenses are not uniform over the microlens array, so that the plurality of focal points of the microlens array are at different image distances from the emission surface, and so that a locus of the plurality of focal points forms a non-planar virtual object surface; and
an optical combiner optically coupled to the micro-display unit, wherein the micro-display is positioned such that the substantially planar emission surface is at a selected angle relative to a plane of the optical combiner, and wherein the optical combiner reflects and images the non-planar virtual object surface formed by the microlens array.

26. The system of claim 25, further comprising an optically transparent dielectric separation layer between the planar emission surface and the microlens array.

27. The system of claim 25 wherein there is a one-to-one correspondence between the individual display pixels and the individual microlenses.

28. The system of claim 25 wherein there is a many-to-one correspondence between the individual display pixels and the individual microlenses.

29. The system of claim 25 wherein the optical combiner is a diffractive optical combiner.

30. An apparatus comprising:
a micro-display including an array of individual display pixels positioned along a substantially planar emission surface, wherein the micro-display is configured to emit display light; and
an optical fiber bundle physically coupled to the planar emission surface, the optical fiber bundle including a plurality of individual optical fibers, each individual optical fiber having a length that spans between a first end and a second end of the individual optical fiber;
wherein each individual optical fiber has its first end physically coupled to the planar emission surface and optically coupled to one or more of the individual display pixels, such that at least a portion of the display light is injected into the first end and propagates through the optical fiber to emerge from the second end, and
wherein the length of at least a first optical fiber in the plurality of individual optical fibers is different than the length of a second optical fiber in the plurality of individual optical fibers, so that a locus including the second ends of the plurality of individual optical fibers form a real non-planar object surface.

31. The apparatus of claim 30, further comprising a microlens array positioned between the planar emission surface and the optical fiber bundle, the microlens array including a plurality of individual microlenses, wherein each of the individual microlenses is optically coupled to one or more of the individual display pixels and to the first ends of one or more individual optical fibers.

32. The apparatus of claim 30 wherein the individual lenses in the microlens array are positioned at a uniform distance from the planar emission surface and have uniform focal lengths.

33. The apparatus of claim 32, further comprising a dielectric spacing layer of uniform thickness positioned between the planar emission surface and the microlens array.

34. A system comprising:
a micro-display unit comprising:
a micro-display including an array of individual display pixels positioned along a substantially planar emission surface, wherein the micro-display is configured to emit display light; and
an optical fiber bundle physically coupled to the planar emission surface, the optical fiber bundle including a plurality of individual optical fibers, each individual optical fiber having a length that spans between a first end and a second end of the individual optical fiber;
wherein each individual optical fiber has its first end physically coupled to the planar emission surface and optically coupled to one or more of the individual display pixels, such that at least a portion of the display light is injected into the first end and propagates through the optical fiber to emerge from the second end, and
wherein the length of at least a first optical fiber in the plurality of individual optical fibers is different than the length of a second optical fiber in the plurality of individual optical fibers, so that a locus including the second ends of the plurality of individual optical fibers form a real non-planar object surface; and
an optical combiner optically coupled to the micro-display unit, wherein the micro-display is positioned such that the substantially planar emission surface is at a selected angle relative to a plane of the optical combiner, wherein the optical combiner images the real non-planar object surface.

35. The system of claim 34, further comprising a microlens array positioned between the planar emission surface and the optical fiber bundle, the microlens array including a plurality of individual microlenses, wherein each of the individual microlenses is optically coupled to one or more of the individual display pixels and to the first ends of one or more individual optical fibers.

36. The apparatus of claim 35 wherein the individual lenses in the microlens array are positioned at a uniform distance from the planar emission surface and have uniform focal lengths.

37. The apparatus of claim 36, further comprising a dielectric spacing layer of uniform thickness positioned between the planar emission surface and the microlens array.

38. The system of claim 34 wherein the optical combiner is a diffractive optical element.

39. The system of claim 34 wherein the micro-display and the optical combiner are mounted on a frame designed to be worn on a head of a user.
